(19) United States
(12) Patent Application Publication
(10) Pub. No.: US 2023/0033036 A1
(43) Pub. Date: Feb. 2, 2023

(54) DISPLAYING AUDIOVISUAL CONTENT TYPE INFORMATION AS A MIND MAP

(71) Applicant: International Business Machines Corporation, Armonk, NY (US)

(72) Inventors: Yan Yan Han, Xi'an (CN); SU LI HOU, Beijing (CN); Yue Yang, Beijing (CN); Jing Xu, Xi'an (CN); Xue Ying Zhang, Xi'an (CN); Li Zhou, Beijing (CN); Zhiyi Xiang, Chongqing (CN)

(21) Appl. No.: 17/389,849

(22) Filed: Jul. 30, 2021

(51) Int. Cl. G06F 16/26; G06F 16/68; G06F 16/78; G06F 16/955; G06F 16/28; G06F 16/2457

(52) U.S. Cl. CPC G06F 16/26; G06F 16/686; G06F 16/7867; G06F 16/9558; G06F 16/282; G06F 16/24578

(57) ABSTRACT

A method for receiving an audiovisual data set that includes audio and/or visual content, receiving a topical data set that includes an indication of, at least, the plurality of topics and the plurality of subtopics, receiving a time mapping data set that maps each topic and subtopic to an associated time point in the audio and/or visual content, creating a mind map diagram, and presenting the mind map to a user.

### BACKGROUND

The present invention relates generally to the field of audiovisual presentations and also to mind map type diagrams.

The Wikipedia entry for “mind map” (as of May 24, 2021) states as follows: “A mind map is a diagram used to visually organize information. A mind map is hierarchical and shows relationships among pieces of the whole. It is often created around a single concept, drawn as an image in the center of a blank page, to which associated representations of ideas such as images, words and parts of words are added. Major ideas are connected directly to the central concept, and other ideas branch out from those major ideas. Mind maps can also be drawn by hand, either as ‘notes’ during a lecture, meeting or planning session, for example, or as higher quality pictures when more time is available. Mind maps are considered to be a type of spider diagram. . . . Mind maps are similar in structure to concept maps, developed by learning experts in the 1970s, but differ in that mind maps are simplified by focusing around a single central key concept. (footnote(s) omitted)

The Wikipedia entry for “audiovisual” (as of 12 Jun. 2021) states as follows: “Audiovisual (AV) is electronic media possessing both a sound and a visual component, such as slide-tape presentations, films, television programs, corporate conferencing, church services, and live theater productions. Audiovisual service providers frequently offer web streaming, video conferencing, and live broadcast services. Computer-based audiovisual equipment is often used in education, with many schools and universities installing projection equipment and using interactive whiteboard technology.” (footnotes omitted)

As the term is used in this document, audiovisual information that includes no audio (video without sound) and also no video (sound with no video).

### SUMMARY

According to an aspect of the present invention, there is a method, computer program product and/or system that performs the following operations (not necessarily in the following order): (i) receiving an audiovisual data set that includes audio and/or visual content that involves a plurality of topics and a plurality of subtopics; (ii) receiving a topical data set that includes an indication of, at least, the plurality of topics and the plurality of subtopics; (iii) receiving a time mapping data set that maps each topic and subtopic to an associated time point in the audio and/or visual content; (iv) creating a mind map diagram that includes an indication of the identity of the audiovisual data set, an indication of each topic, an indication of each subtopic and user interface devices so that a user may select any of the topics and/or subtopics; and (v) presenting the mind map to a user as a display on a display device of a computer system.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a screenshot view generated by the first embodiment system.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

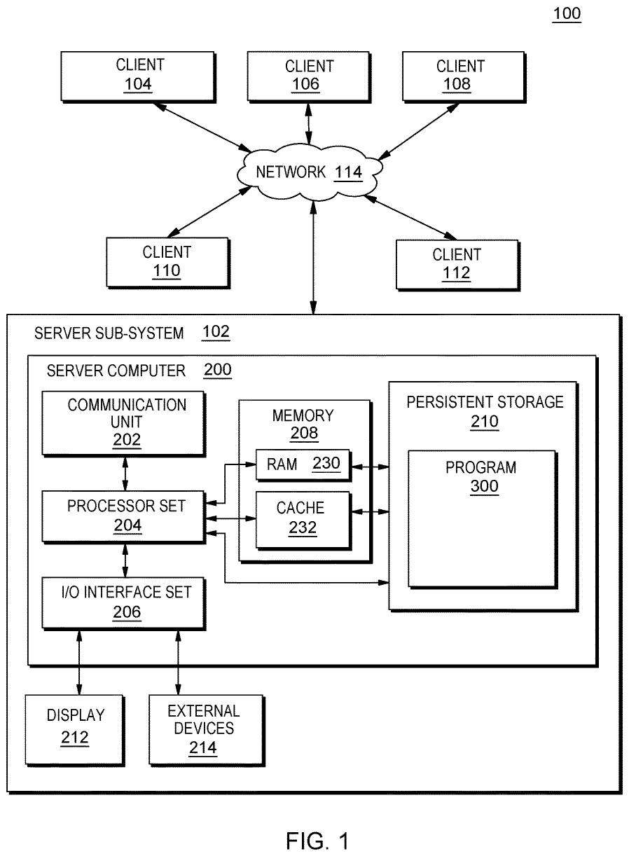

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

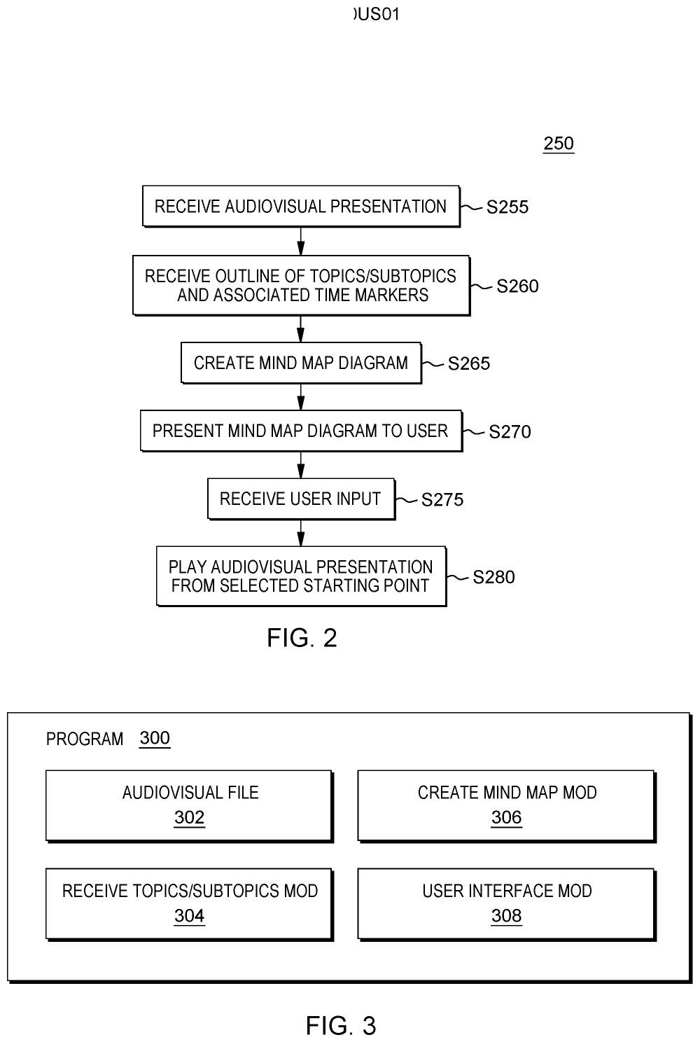

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

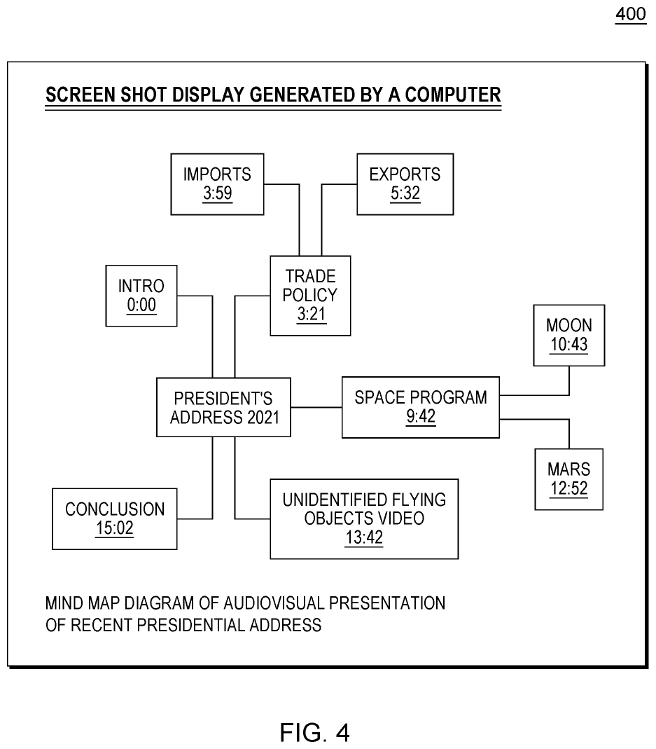

Processing begins at operation S255, where program 300 receives audiovisual file 302 from client subsystem 104 and through network 114. In this example, the audiovisual file includes audio content, video content and metadata. In this example, the audiovisual data needed to perform the method of flowchart 250 is received as an *.avi file. Alternatively, this data can be received other ways, for example, by streaming. In this example, the audiovisual content is a president of a nation giving a speech to the nation that she helps to govern. The speech is entitled “President's Address” (see center of screenshot 400 of FIG. 4). Some embodiments of the present invention only focus on the video, which is sharing the documents and giving the audio description, based on the shared documents, and does not contain video, such as a movie. Further, according to some embodiments of the present invention, the “President's Address” speech example stated above may be considered a shared document.

As mentioned above, audiovisual files that can be used in various embodiments of the present invention will typically include audio content, video content and metadata. One type of metadata, used by some embodiments of the present invention, is indication content. Some embodiments of the present invention only focus on the video which is sharing the documents and giving the audio description based on the shared documents. These embodiments do not typically work with audiovisual content of the type seen in movies. In some embodiments, audio content, like speech, may be used in a manner analogous to the way that the shared documents are used.

Processing proceeds to operation S260, where receive topics/subtopics module (“mod”) 304 receives a hierarchical list of topics and sub-topics that are present in the audiovisual content. In this example, the list of topics/subtopics are based on an expert evaluation of the President's Address, and are also received from client sub-system 104. Alternatively, mod 304 could be equipped with machine logic (for example, machine learning algorithms) that can derive a list of topics and sub-topics from audiovisual content without human assistance. In this example, there are only two levels of topic granularity, that is: (i) topic level; and (ii) sub-topic level. Alternatively, there can be additional layers, like sub-sub-topics and sub-sub-sub-topics. Also, some of the connections may be non-hierarchical (for example, a single sub-topic could connect with two distinct topics). In this example, the topics are the following five (5): introduction, trade policy, space program, a recently surfaced unidentified flying object video and conclusion. The sub-topics will be readily apparent from a review of screenshot 400. In this example, only two topics have sub-topics.

Processing proceeds to operation S265, where create mind map mod 306 creates the mind map diagram of the Presidents Address, as shown in screenshot 400. In creating the mind map diagram, mod 306 determines a time, within the audiovisual content, where each topic and sub-topic are introduced. These times are included as selectable links in the mind map, again, as shown in screenshot 400.

Processing proceeds to operation S270, where mod 306 sends data corresponding to the mind map diagram to a user at client subsystem 106. Screenshot 400 is what is actually displayed on the touchscreen of the user's tablet computer in this example.

Processing proceeds to operation S275, where user interface mod 308 receives user input in the form of selection of one of the links in the mind map diagram, thereby indicating that a user wants to navigate to a certain topic or sub-topic of the mind map diagram shown in screenshot 400. In this example, the user of client subsystem 106 wants to hear about the UFOs (unidentified flying objects), so she has clicked the link labelled 13:42 in screenshot 400.

Processing proceeds to operation S280, where user interface mod 308 sends a communication to client subsystem 106 in order to cause it to play the President's Address audiovisual presentation locally, starting from 13:42, which is where the president explains that the UFOs belong to people who are travelling in time and that they should be left alone because they are harmless. This is the information that the user of client sub-system 106 really wanted to hear—she is just not that interested in trade policy, not export side and not even import side. The clickable user interface provided by the mind map of screenshot 400 helped her quickly navigate to where she wanted to be in that video.

### III. Further Comments and/or Embodiments

Some embodiments of the present invention recognize the following facts, potential problems and/or potential areas for improvement with respect to the current state of the art: (i) there will be a lot of meetings or training when performing work or studying; (ii) from these meetings or training, a lot of useful information will be obtained; and/or (iii) since users/people do not remember the details in a timely manner, key information may be missed.

Some embodiments of the present invention recognize the following facts, potential problems and/or potential areas for improvement with respect to the current state of the art: (i) when doing training or having a meeting, documents are often shared and an audio description is created based on the shared documents; (ii) the training or meeting is always recorded to video material; (iii) if someone would like to know the content of materials, that someone has to listen to and watch the video again; and/or (iv) if someone wants to find some information from the video materials, they would have to go through the video again, which consumes a great deal of time.

Some embodiments of the present invention may include one, or more, of the following operations, features, characteristics and/or advantages: (i) has the ability to divide the video content into three parts: audio, image, indictor; (ii) has the ability to convert audio, image, and indictor to text separately, then combine them to a complete text with a timestamp; (iii) has the ability to build the knowledge graphs based on the complete text with a timestamp; (iv) has the ability to combine the knowledge graphs to one or several knowledge graph trees based on the text structure; and/or (v) has the ability to create a mind map according to the knowledge graph trees.

Some embodiments of the present invention may include one, or more, of the following operations, features, characteristics and/or advantages: (i) convents the text to knowledge graphs and to several knowledge graph trees; (ii) creates a mind map; (iii) convents the text to knowledge graphs and several knowledge graph trees to create a mind map; and/or (iv) uses all the text to create the knowledge graphs trees and then creates a mind map based on the text.

Some embodiments of the present invention may include one, or more, of the following operations, features, characteristics and/or advantages: (i) has the ability to better record and understand the key information in meetings or during training; (ii) can automatically generate a mind map after training and meetings; (iii) can record the main information of training and meetings in a graphical way; (iv) a user can click on a part of the mind map, and the corresponding video associated with this part will open automatically; and/or (v) makes it easier for participants to understand and find training and meeting content more accurately and quickly.

Some embodiments of the present invention may include one, or more, of the following operations, features, characteristics and/or advantages: (i) during training or meetings, the voice record is converted into text; (ii) at the same time as item (i) above is happening, images are converted into text; (iii) has the ability to extract the topics and the corresponding time point by AI (artificial intelligence); (iv) converts audio and video into a mind map according to the structure of that type of topic; (v) divides the image in the mind map into several parts where each part corresponds to a topic and a time point; and/or (vi) when a user clicks on a part of the mind map, the video will automatically display the corresponding content.

Some embodiments of the present invention may include one, or more, of the following operations, features, characteristics and/or advantages: (i) has the ability to check the video content easily and efficiently without listening to or watching the video; (ii) could search text from the video easily and efficiently; (iii) the text consists of audio, image semantics and indicator meaning; (iv) indicator makes the relationship between audio and the images clearer; and/or (v) makes the meaning of the text more accurate.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) comprising:
receiving an audiovisual data set that includes audiovisual content that includes audio and/or visual representations regarding a plurality of topics, with at least some of the topics respectively including at least one subtopic;
divide the audiovisual content into three parts: audio part, image part, indictor part;
converting the audio part to audio-based text;
converting the video part to video-based text;
converting the indicator part to indicator-based text;
combining the audio-based text, the video-based text and the indicator-based text into a complete text with timestamps;
creating a mind map diagram based on the complete text with timestamps; and
presenting the mind map to a user as a display on a display device of a computer system.

2. The CIM of claim 1
wherein the creation of the mind map diagram includes:
creating an audio-based knowledge graph based on the audio-based text;
creating a video-based knowledge graph based on the video-based text; and
creating an indicator-based graph based on the indicator-based text; and
combining the audio-based knowledge graph, the video-based knowledge graph and the indicator-based knowledge graph to create the mind map diagram.

3-18. (canceled)

19. A computer program product (CPP) comprising:
a set of storage device(s); and
non-transitory computer code stored collectively in the set of storage device(s), with the computer code including data and instructions to cause a processor(s) set to perform at least the following operations:
receiving an audiovisual data set that includes audiovisual content that includes audio and/or visual representations regarding a plurality of topics, with at least some of the topics respectively including at least one subtopic,
divide the audiovisual content into three parts: audio part, image part, indictor part,
converting the audio part to audio-based text,
converting the video part to video-based text,
converting the indicator part to indicator-based text,
combining the audio-based text, the video-based text and the indicator-based text into a complete text with timestamps,
creating a mind map diagram based on the complete text with timestamps, and
presenting the mind map to a user as a display on a display device of a computer system.

20. The CPP of claim 19 wherein the creation of the mind map diagram includes:
creating an audio-based knowledge graph based on the audio-based text;
creating a video-based knowledge graph based on the video-based text; and
creating an indicator-based graph based on the indicator-based text; and
combining the audio-based knowledge graph, the video-based knowledge graph and the indicator-based knowledge graph to create the mind map diagram.

21. A computer system (CS) comprising:
a processor(s) set;
a set of storage device(s); and
computer code stored collectively in the set of storage device(s), with the computer code including data and instructions to cause the processor(s) set to perform at least the following operations:
receiving an audiovisual data set that includes audiovisual content that includes audio and/or visual representations regarding a plurality of topics, with at least some of the topics respectively including at least one subtopic,
divide the audiovisual content into three parts: audio part, image part, indictor per,
converting the audio part to audio-based text,
converting the video part to video-based text,
converting the indicator part to indicator-based text,
combining the audio-based text, the video-based text and the indicator-based text into a complete text with timestamps,
creating a mind map diagram based on the complete text with timestamps, and
presenting the mind map to a user as a display on a display device of a computer system.

22. The CS of claim 21 wherein the creation of the mind map diagram includes:
creating an audio-based knowledge graph based on the audio-based text;
creating a video-based knowledge graph based on the video-based text; and
creating an indicator-based graph based on the indicator-based text; and
combining the audio-based knowledge graph, the video-based knowledge graph and the indicator-based knowledge graph to create the mind map diagram.
